(19) United States
(12) Patent Application Publication
(10) Pub. No.: US 2015/0008896 A1
(43) Pub. Date: Jan. 8, 2015

(54) CONSTANT RESISTANCE TO CONSTANT CURRENT/CONSTANT POWER START-UP

(71) Applicant: Experium Technologies, LLC, Upper Marlboro, MD (US)

(72) Inventor: Lance Palatini, Morris Plains, NJ (US)

(21) Appl. No.: 13/933,233

(22) Filed: Jul. 2, 2013

(51) Int. Cl. G05F 5/00

(52) U.S. Cl. CPC G05F 5/00
USPC 323/303

(57) ABSTRACT

A constant current and constant power method and system for controlling current drawn from a voltage source uses an electronic load device such as one or more field effect transistors connected with the voltage source via a switch. The load device is configured as a resistance device. A constant resistance, a cutover voltage, and either a constant current or a constant power are set by the user for the voltage source. When the switch is closed, a fixed current is drawn from the voltage source to the load and the voltage from the source is measured. The measured voltage is compared with the cutover voltage. When the measured voltage is less than the cutover voltage, the current to the load is maintained in accordance with the measured voltage and the constant resistance. When the measure voltage exceeds the cutover voltage, the current to the load device is switched to a constant current or the load device is switched to constant power. This allows the voltage source to be gradually brought up to a desired output voltage.

### BACKGROUND OF THE INVENTION

An electronic load is a device which has the ability to control current from a voltage source. In a constant current application, the electronic device attempts to draw a fixed amount of current from the voltage source. In a constant power application, the electronic load attempts to draw current from the voltage source in inverse proportion to the voltage supplied. In a constant resistance application, the electronic device will attempt to draw current from the voltage source according to Ohm's Law and thus simulate a fixed resistance value.

Many types of voltage sources exist and it is often found that these devices cannot turn on into a constant current or constant power load because when the voltage source is energized, the source will be at or near zero volts and the immediate large draw of current prevents the voltage provided by source from rising to the desired level.

The solution afforded by the invention is to turn the voltage source into a constant resistance load condition until the output voltage from the source has risen to an acceptable value and then switch to a constant current or constant power operation.

### BRIEF DESCRIPTION OF THE PRIOR ART

Constant current generating and control devices are known in the patented prior art as evidenced by the Haranda U.S. Pat. No. 5,696,440 and Hsu U.S. Pat. No. 7,924,581. Harada discloses a constant current generating apparatus including a constant current circuit, an activation circuit which for the constant current circuit, and a control circuit which turns on the activation circuit in accordance with the potential at an output terminal. Hsu teaches a high voltage start-up circuit with constant current control applied to a switching mode power converter. The start-up circuit includes a high voltage junction transistor.

While the prior devices operate satisfactorily, they do not afford the “soft start” capability for a power supply which is necessary to achieve full voltage output. The present invention was developed in order to overcome these and other drawbacks by providing a power supply system connected with an electronic load which is capable of achieving a gradual increase in the output voltage of the system and a method for operating the same.

### SUMMARY OF THE INVENTION

Accordingly, it is a primary object of the invention to provide a method for controlling the current drawn from a voltage source using an electronic load connected to the source via a switch. A constant resistance value and a cutover voltage are set for the voltage source. The switch is closed to draw a fixed current from the source to the load. The voltage from the source is measured and compared to the cutover voltage. When the measured voltage is less than the cutover voltage, the current to the load device is maintained according to the constant resistance value until the measured voltage exceeds the cutover voltage. When the measured voltage exceeds the cutover voltage, the current to the load device is switched to a constant current value. The method thus allows the voltage source to gradually be increased to a desired level.

In an alternate embodiment, when the measured voltage is greater than the cutover voltage, the load device is switched to a constant power value and the load current is set in inverse proportion to the voltage supplied to the load device.

The load device preferably includes a field effect transistor and the voltage is measured at the gate of the transistor.

Operation of the voltage source is controlled by a microprocessor connected with an analog to digital converter. The microprocessor also controls the current from the voltage source in direct proportion to the voltage applied to the load in the constant current embodiment and in inverse proportion to the voltage applied to the load in the constant power embodiment.

A further object of the invention is to provide a power supply system including a voltage source, an electronic load connected with the voltage source via a switch, and a microprocessor connected with the voltage source for controlling the current delivered from the source to the load in accordance with the output voltage from the source. The microprocessor sets the current to the load to a constant resistance value when the output voltage is less than a set voltage. When the output voltage reaches a set voltage, the current to the load is switched to a constant current or the load device is switched to a constant power. Thus, the output voltage gradually increases to the set voltage.

### BRIEF DESCRIPTION OF THE FIGURES

Other objects and advantages of the invention will become apparent from a study of the following specification when viewed in the light of the accompanying drawing, in which:

FIG. 1 is a schematic diagram of an electronic load system for controlling high currents;

FIG. 2 is a detailed block diagram of the electronic load system shown in FIG. 1;

FIG. 3 is a circuit diagram of a load used to control the current from a voltage source;

FIG. 4 is a flow diagram of the voltage controlled constant resistance to constant current start up for a power system according to one embodiment of the invention;

FIG. 5 is a graph illustrating the current produced when the invention is used in constant current mode;

FIG. 6 is a flow diagram of the voltage controlled constant resistance to constant power start up for a power system according to an alternate embodiment of the invention; and

FIG. 7 is a graph illustrating the current produced when the invention is used in a constant power mode.

### DETAILED DESCRIPTION

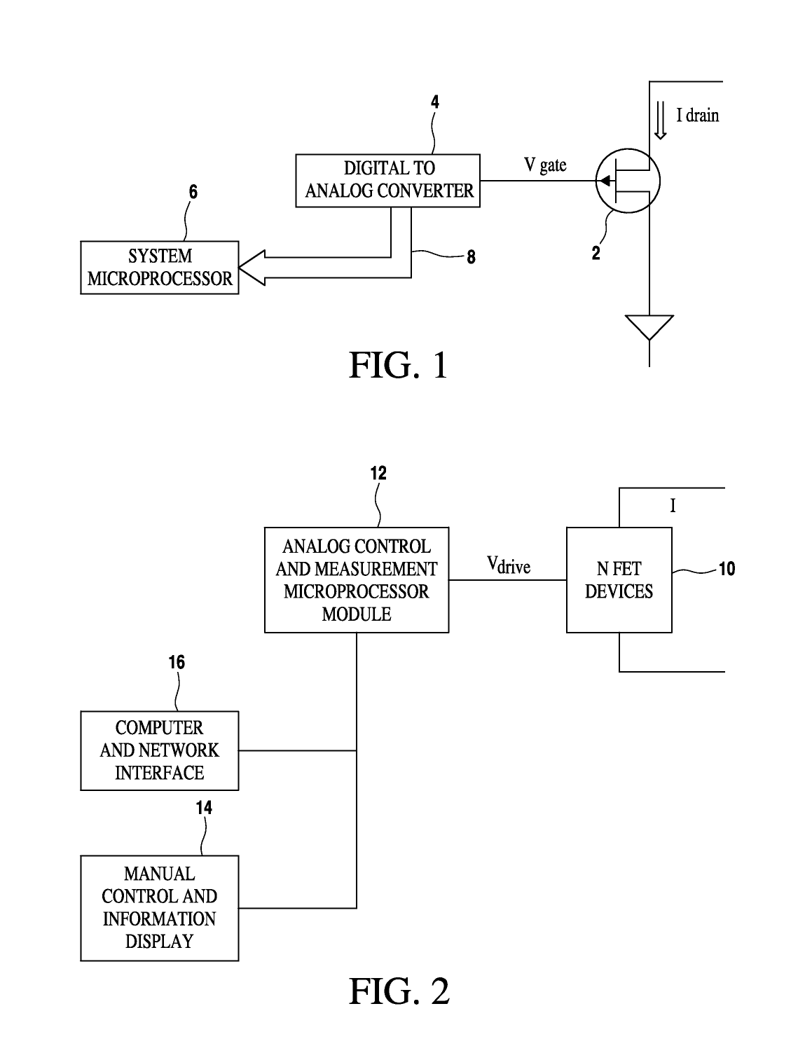

A transistorized load system simulates the current drawn by a load device on an electronic power source by using the current control capacity of a field effect transistor (FET). A field effect transistor is an elemental electrical device where the current through the device is controlled by the voltage applied to a specific terminal. Referring to FIG. 1, there is shown an FET 2 connected with a digital to analog converter 4 which is connected with a system microprocessor 6 via a data bus 8. The current I_{drain} through two terminals of the FET is proportional to the voltage V_{gate} applied to the third or gate terminal of the FET. This current is determined according to the equation

I_{drain}=Constant*V_{gate} (1)

In an electronic load system, multiple FET devices are connected in parallel to achieve the maximum desired current. In addition, the control voltage applied to the load device is created by the digital to analog converter 4 connected to the system microprocessor 6 where the microprocessor sends a binary digital pattern V_{binary} to the digital to analog converter. The digital to analog converter generates the appropriate V_{gate} signal to the FET as follows:

V_{gate}=Constant*V_{binary} (2)

Combining equations (1) and (2) yields the following equation:

I_{drain}=Constant*V_{binary} (3)

The electronic load system uses this relationship to create high currents that can be controlled in a very precise manner. Referring to FIG. 2, the load 10 comprises N field effect transistors. The current I through the load device is determined according to the following equation:

I=Constant*V_{drive} (4)

where V_{drive} is the voltage provided at the input to the load device by the analog control and measurement microprocessor module 12. The desired current is determined by the user either via a manual control interface 14 or a computer network interface 16 both of which are connected with the analog control and measurement microprocessor module.

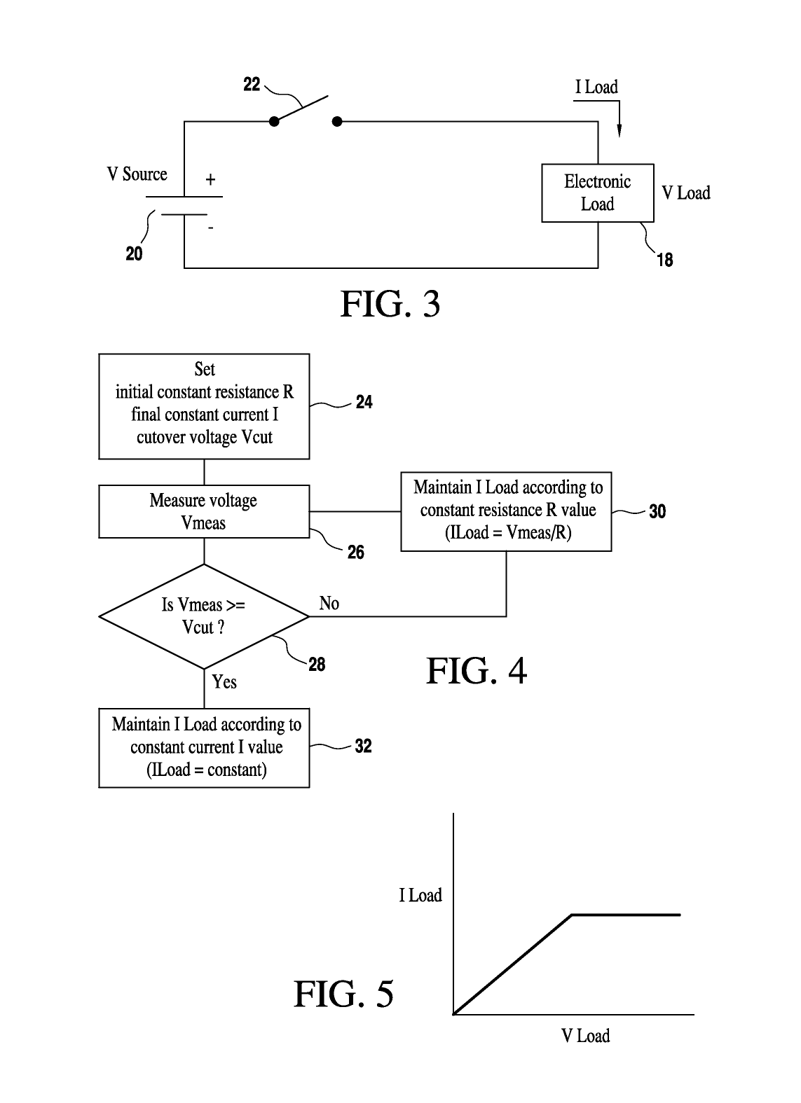

FIG. 3 is a circuit diagram showing how an electronic load 18, such as a plurality of FET devices similar to the load 10 in FIG. 2, can be used to control the current drawn from a voltage source 20. The load is connected in series with the voltage source via a switch 22. In a constant current application, the electronic load will attempt to draw a fixed amount of current L_{loadc} from the voltage source. When the switch 22 is closed, the current L_{loadc} through the load starts at a fixed value and is maintained at that level regardless of the value of the output voltage from the voltage source. Thus,

I_{loadc}=constant (5)

Because the current through the load can be controlled to maintain a fixed value, it can simulate a constant current loading effect. The control voltage to the load, which would be the gate voltage to the FETs of the load, is maintained by a microprocessor (FIG. 1) so that the value I_{loadc} is maintained at a fixed value.

The circuit of FIG. 3 can also be used in a constant power application. In such cases, the electronic load will attempt to dissipate a fixed amount of power from the voltage source. When the switch 22 is closed, the current through the load I_{loadp} starts at a maximum value and falls linearly with increasing voltage. Thus,

I_{loadp}=P/V_{load} (7)

where P is the constant power load value.

If the voltage V_{load} applied to the electronic load falls to zero, the current through the load will be set to its maximum allowed value.

Because the desired current through the load can be defined by a linear equation, an electronic load can use its internal microprocessor to perform this calculation to simulate the constant power loading effect mathematically.

In the electronic load, the control voltage to the FETs, i.e. the voltage V_{gate}, is maintained by the microprocessor so that the ration I_{load}/V_{load} is maintained at a fixed value, thus simulating the constant power load value P.

A method for constant resistance operation of the circuit of FIG. 3 with voltage controlled turn on will be described with reference to FIGS. 4 and 5.

Many types of voltage sources exist and it is often found that these devices cannot turn on into a constant current load as the immediate draw of current prevents the voltage provided by the source from rising to the desired output level. The problem can be solved by turning on the voltage source under a desired resistance load condition until such time as the output voltage of the source has increased to an acceptable value and then switching the source to constant current operation.

Using the manual control (FIG. 2), an initial constant resistance R, a final constant current I and a cutover voltage V_{cut} are set by the user at step 24 of FIG. 4. When the switch 22 is closed, the current through the electronic load 18 starts at zero and rises linearly with increasing voltage according to the desired constant resistance value. The output voltage Vₘₑₐₛ is measured at step 26 and compared with the cutover voltage at step 28. Until the measured voltage reaches the cutover voltage, the load current is maintained according to the constant resistance R value at step 30. The load current is maintained according to the following relationship:

I_{load}=Vₘₑₐₛ/R (8)

When the measured voltage exceeds the cutover voltage, the electronic load changes to constant current mode and the load current is maintained at a fixed value at step 32. A graph showing the load current during these steps is shown in FIG. 5. The operation and switching of the load is controlled by the microprocessor (FIG. 1). The current from the voltage source is controlled in direct proportion to the voltage applied to the electronic load device. Using the voltage control of constant current of the source, the source is gradually brought to the desired voltage level.

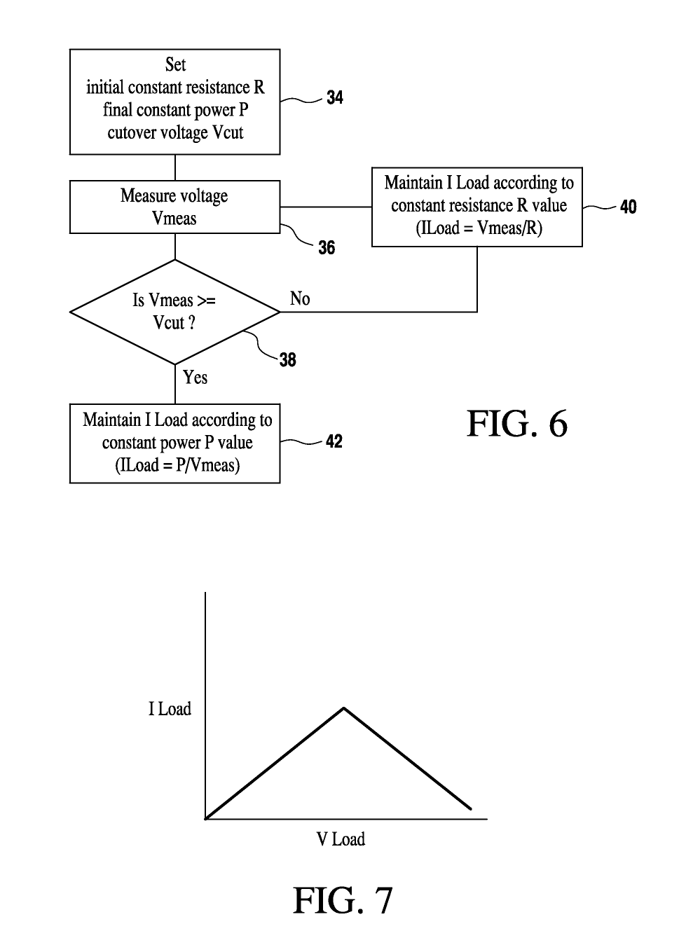

A method for constant power operation of the circuit of FIG. 3 will be described with reference to FIGS. 6 and 7.

Using the manual control (FIG. 2), an initial constant resistance R, a final constant power P and a cutover voltage V_{cut} are set by the user at step 34 of FIG. 6. When the switch 22 is closed a fixed current is drawn from the voltage source and the current through the electronic load 18 starts at zero amps and rises linearly with increasing voltage according to the desired constant resistance value. The output voltage Vₘₑₐₛ is measured at step 36 and compared with the cutover voltage at step 38. Until the measured voltage reaches the cutover voltage, the current is maintained according to the following equation:

I_{load}=Vₘₑₐₛ/R (7)

This is shown at step 40. When the measured voltage exceeds the cutover voltage, the electronic load changes to constant power mode and the load current is set in inverse proportion to the supplied voltage at step 42. A graph showing the load current during these steps is shown in FIG. 7. The operation and switching of the load is controlled by the microprocessor (FIG. 1). The current from the voltage source is controlled in inverse proportion to the voltage applied to the electronic load device. Using the voltage control of constant current of the source, the source is gradually brought to the desired voltage level.

While the preferred forms and embodiments of the invention have been illustrated and described, it will be apparent to those of ordinary skill in the art that various changes and modifications may be made without deviating from the inventive concepts set forth above.

What is claimed is:

1. A method for controlling current drawn from a voltage source, comprising the steps of
(a) connecting an electronic load device to the voltage source via a switch;
(b) setting a constant resistance, a final constant current value and a cutover voltage for the voltage source;
(c) closing the switch to draw a fixed current from the voltage source to the load;
(d) measuring the voltage from the voltage source;
(e) comparing the measured voltage with the cutover voltage;
(f) maintaining the current to the load device in accordance with the measured voltage relative to the constant resistance until the measured voltage reaches the cutover voltage; and
(g) switching the current to the load device to the final constant current value when the measured voltage is greater than the cutover voltage, whereby the output voltage from the voltage source gradually increases to the set voltage.

2. A method as defined in claim 1, wherein said load device includes a field effect transistor.

3. A method as defined in claim 2, wherein said voltage is measured at a gate of said field effect transistor.

4. A method as defined in claim 3, wherein said voltage source is controlled by a microprocessor connected with an analog to digital converter.

5. A method as defined in claim 4, wherein said microprocessor controls the current from the voltage source in direct proportion to the voltage applied to the electronic load device.

6. A method for controlling current drawn from a voltage source, comprising the steps of
(a) connecting an electronic load device to the voltage source via a switch;
(b) setting an initial constant resistance, a constant power value and a cutover voltage for the voltage source
(c) closing the switch to draw a fixed current from the voltage source to the load;
(d) measuring the voltage from the voltage source;
(e) comparing the measured voltage with the cutover voltage;
(f) maintaining the current to the load device as a function of the measured voltage and the constant resistance value until the measured voltage reaches the cutover voltage; and
(g) switching the load device to a constant power and setting the current in inverse proportion to the voltage applied to the electronic load device when the measured voltage is greater than the cutover voltage, whereby the output voltage from the voltage source gradually increases to the set voltage.

7. A method as defined in claim 6, wherein said load device includes a field effect transistor.

8. A method as defined in claim 7, wherein said voltage is measured at a gate of said field effect transistor.

9. A method as defined in claim 8, wherein said voltage source is controlled by a microprocessor connected with an analog to digital converter.

10. A method as defined in claim 9, wherein said microprocessor controls the current from the voltage source in inverse proportion to the voltage applied to the electronic load device.

11. A power supply system, comprising
(a) a voltage source;
(b) an electronic load connected with said voltage source via a switch;
(c) a microprocessor connected with said voltage source for controlling the current delivered from the voltage source to the load in accordance with the output voltage from said voltage source, said microprocessor setting the resistance of the load to a constant value, maintaining the current to the load device as a function of the resistance when the output voltage is less than a set voltage while the output voltage increases, and switching the current to the load to a constant current or switching the load device to a constant power when the output voltage exceeds the set voltage, whereby the output voltage from the voltage source gradually increases to the set voltage.
